(19) United States
(12) Patent Application Publication
(10) Pub. No.: US 2005/0016917 A1
(43) Pub. Date: Jan. 27, 2005

(54) High efficiency filter material and composition

(76) Inventor: Qi Meng, Toronto (CA)

Correspondence Address: DAVID W. WONG, 46 WILLOWBROOK ROAD, THORNHILL, ON, L3T 4W9, CA

(21) Appl. No.: 10/626,307

(22) Filed: Jul. 25, 2003

(51) Int. Cl. B01D 39/00

(52) U.S. Cl. 210/503

(57) ABSTRACT

A high efficiency elastic porous filter material is made from a composition of a mixture of powder of ultra high molecular weight polyethylene, high density polyethylene and low density polyethylene and a selected filler material. The filter material is insert to acid, alkaline and other corrosive fluid, and has evenly distributed same size interstice openings or voids. Impurities in the fluid, air, or oil being filtered are suspended outside of the filter material without causing clogging to occur in the interstice openings. The material may be fabricated in various shapes for various filter operations by fusing the mixture in selected molds.

### FIELD OF THE INVENTION

This invention relates to filter materials and a variety of compositions of making the same, and particularly the composition and the process of making of high efficiency filter materials.

### BACKGROUND OF THE INVENTION

Woven or non-woven fibrous material such as paper, felt or other fuzzy fabrics are commonly used for making filters for filtering water, oil, and air etc. Such fibrous material has void interstices dispersed in a random fashion in a fiber mass, and surface of the side walls of the void interstices are fuzzy and not smooth. The void interstices are irregular in sizes and they provide tortuous paths for the air or fluid to flow through while any pollutant or particulate impurities carried in the air or fluid would be trapped in the voids with rough or fuzzy side walls and smaller in size than the impurities; however, a large amount of pollutant and particulate impurities flow freely through the filter through the larger voids due to that the sizes of the void interstices are not even. Since the size and distribution of the void interstices are random and are not predictable in common filter material, they are thus low in efficiency and do not provide precision filtering operation. Also, the rough and fuzzy side walls of the void interstices render high flow resistance to the liquid or fluid being filtered. Other filters with complex constructions have been used, but they are difficult and expensive to fabricate. In order to achieve precision filtering operation, the void interstices in the filter must not be larger than certain dimensions in different applications, for example, for filtering water, the void openings must not be larger than about 5 micrometers; for filtering liquid fuel such as gasoline and diesel oil, the void openings must not be larger than about 10 micrometers; for filtering lubricating oil, the void openings must not be larger than about 25 micrometers; and for filtering various kinds of gas, the void openings must not be larger than 40 micrometers.

Also in operation, the voids of the filter with the rough and fuzzy side walls are filled with accumulation of the pollutant and particulate impurities trapped therein so that eventually air or fluid would no longer flow through the filter material because the voids within it are entirely blocked with accumulation. The blocked filter material may not be cleaned to remove the pollutant and particulate impurities lodged in the void interstices for re-using the filter, since common filters are not made of durable materials such that they will lose their body integrity and will disintegrate in the cleaning operation rendering them completely useless. While disposal of such clogged dirty filters would contribute to the pollution of the environment. High quality paper filter materials must necessarily be made from wood. This would increase to the depletion of forest and would contribute to the destruction of the natural environment.

Furthermore, known filter materials are not resistant to acidic or alkaline solutions, or other corrosive fluids and would be destroyed if they are used for filtering such materials.

### SUMMARY OF THE INVENTION

It is a principal object of the present invention to provide a unique filtering material which has substantially similar size interstice openings with smooth side walls and evenly distributed throughout its entirety.

It is another object of the present invention to provide a filter material in which the dimension of the interstice openings may be controlled during fabrication so as to provide filters suitable for different precision filtering applications.

It is another object of the present invention to provide a filter material which is extremely durable and may be repeatedly and easily cleaned for re-use.

It is yet another object of the present invention to provide an inert filter material which is highly resistant to acid, alkaline, and corrosive solutions such that it is applicable for filtering a wide variety of materials.

It is still another object of the present invention to provide a filter material which is non-absorptive of the liquid and fluid being filtered such that it provides high filtering operation without resistant to the fluid flow and it has a long useful life.

### BRIEF DESCRIPTION OF THE DRAWINGS

Other objects and advantages of the present invention will become apparent from the following detailed description of the preferred embodiments thereof in connection with the accompanying drawings in which

FIG. 1 is a perspective elevation view of the filter material of the present invention in a sheet form.

FIG. 2 is a perspective elevation view of the filter material of the present invention in a tubular form.

FIG. 3 is a perspective view of the filter material in a corrugated sheet form.

FIG. 4 is a perspective elevation view of the tubular material provided with corrugation.

FIG. 5 is a perspective end elevation view of the tubular material of FIG. 4.

FIG. 6 is a perspective side elevation view of the corrugated tubular material of FIG. 4.

### DETAILED DESCRIPTION OF THE PREFERRED EMBODIMENTS

The basic substance for making the filter material of the present invention is ultra high molecular weight polyethylene (UHMWPE) which may be formed into long fibers, but normally the fibers are rather brittle in characteristics. I have discovered that when ultra high molecular weight polyethylene powder is mixed with suitable amount of powder of lower density polyethylene (LDPE) and high density polyethylene (HDPE) and other filler substances, and is fused to its melting temperature, a porous elastic unique filter material may be formed. The unique filter material comprises of a plurality of essentially equal size linked plastic spheroids with orderly dispersed interstice openings or voids of substantially same dimension and smooth side walls. The material has extremely low absorption of liquid material. The dimension of the interstice openings or voids may be accurately controlled by varying the proportions and physical size of the ingredients in the composition. When the unique filter material is used for filtering operation, impurities in the fluid or air being filtered would be blocked by the interstice openings all having substantially the same predetermined size and smooth side walls such that the impurities are suspended outside of the filter rather than accumulated inside the interstice voids as in common filter material. Therefore, the impurities would not impede the flow of the fluid or air being filtered. Furthermore, the filter material is extremely durable and resistant to acid, alkaline, and other corrosive liquids. Also it can be cleaned easily and repeatedly to remove any impurities which may have deposited on its surface and it still retains its body integrity without deterioration. The filter material may also be produced in various forms or shapes by molding process to facilitate its use for different filtering applications.

Generally, the following sizes of interstice openings are required for providing high efficiency filtering for various applications. For example:
(1) For water filtration: the size of the interstice openings is about 5 micrometer in diameter.

(2) For filtration of fuel fluid, such as gasoline and diesel oil, the size of the interstice openings is about 10 micrometer in diameter.

(3) For lubricating fluid and hydraulic fluid filtration: the size of the interstice openings is about 18 to 28 micrometers in diameter.

(4) For gas and air filtration: the size of the interstice openings is about 40 micrometers in diameter.

The size of the interstice openings can be controlled with the selection of particulate size of the ingredients in the composition.

For water filtration purposes, in order to obtain interstice openings of about 5 micrometers, the composition of the ingredients is as follows:
1 portion in proportion by volume of ultra high molecular weight polyethylene (UHMWPE) powder with particulate size of 10 to 15 micrometers;
0.15 to 0.4 portion in proportion by volume of low density polyethylene (LDPE) powder with particulate size of 10 to 15 micrometers;
0.05 to 0.15 portion in proportion by volume of high density polyethylene (HDPE) powder with particulate size of 10 to 15 micrometers; and
2.5 to 4.0 portions in proportion by volume of active carbon powder with particulate size of about 20 micrometers.

For fuel fluid and cooling fluid for electrical equipment fitration purposes, in order to obtain interstice openings of about 10 micrometers, the composition of the ingredients is as follows:
1 portion in proportion by volume of ultra high molecular weight polyethylene (UHMWPE) powder with particulate size of about 10 micrometers;
0.03 to 0.08 portion in proportion by volume of low density polyethylene (LDPE) powder with particulate size of about 15 micrometers;
0.05 to 0.1 portion in proportion by volume of high density polyethylene (HDPE) powder with particulate size of about 15 micrometers;
0.05 to 0.1 portion in proportion by volume of an alkaline powder with particulate size of about 10 micrometers; and
0.1 to 0.2 portion in proportion by volume of polyphenylene oxide (PPO) powder with particulate size of about 15 micrometers.

For lubricating oil and hydraulic fluid filtration, in order to obtain interstice openings in the size of 18 to 28 micrometers, the composition of the ingredients is as follows:
1 portion in proportion by volume of ultra high molecular weight polyethylene (UHMWPE) powder with particulate size of 20 to 30 micrometers;
0.10 to 0.20 portion in proportion by volume of high density polyethylene (HDPE) powder with particulate size of about 25 micrometers;
0.03 to 0.08 portion in proportion by volume of low density polyethylene (LDPE) powder with particulate size of about 25 micrometers;
0.05 to 0.15 portion in proportion by volume of polytetrafluoroethylene (PTFE) powder with particulate size of about 25 micrometers;
0.05 to 0.15 portion in proportion by volume of polyamide (PA) powder with particulate size of about 25 micrometers;
0.05 to 0.15 portion in proportion by volume of phenolformaldehyde resin ((PF) powder with particulate size of about 25 micrometers
0.15 to 0.3 portion in proportion by volume of alkaline powder with particulate size of about 20 micrometers; and
0.10 to 0.25 portion in proportion by volume of salt with particulate size of about 25 micrometers.

For outdoor air filtration purposes the interstice openings of the filter may be in the range of 35 to 45 micrometer, and the ingredients of the composition is as follows:
1 portion in proportion by volume of ultra high molecular weight polyethylene (UHMWPE) powder with particulate size of about 40 micrometer;
0.10 to 0.2 portion in proportion by volume of high density polyethylene (HDPE) powder with particulate size of about 40 micrometers;
0.03 to 0.08 portion in proportion by volume of low density polyethylene (LDPE) powder with particulate size of about 40 micrometers;
0.05 to 0.15 portion in proportion by volume of polypropylene (PP) powder with particulate size of about 40 micrometers;
0.05 to 0.15 portion in proportion by volume of polyamide (PA) powder with particulate size of about 40 micrometers;
0.15 to 0.3 portion in proportion by volume of alkaline powder with particulate size of about 20 micrometers; and
0.10 to 0.25 portion in proportion by volume of salt with particulate size of about 40 micrometers.

For indoor air filtration purposes the interstice openings of the filter may be in the range of 15 to 25 micrometer, and the ingredients of the composition is as follows:
1 portion in proportion by volume of ultra high molecular weight polyethylene (UHMWPE) powder with particulate size of about 25 micrometers;
2.5 to 4 portions in proportion by volume of active carbon powder with particulate size of about 20 micrometers;
0.10 to 0.25 portion in proportion by volume of high density polyethylene (HDPE) powder with particulate size of about 30 micrometers;
0.15 to 0.35 portion in proportion by volume of low density polyethylene (LDPE) powder with particulate size of about 30 micrometers; and
0.05 to 0.15 portion in proportion by volume of alkaline powder with particulate size of about 20 micrometers.

The filter material is produced by mixing the powder ingredients thoroughly and then placing and compacting the mixture in a refractory mold. The mold in heated, such as in an electric oven, to a temperature of about 160 to 320° C. for a period of 30 to 90 minutes to fuse the mixture thoroughly within the mold. The mold in then quickly cooled such as by immersing it into cold water for 30 seconds to 1 minute so that the filter material formed therein may be easily removed from the mold. After removing from the mold, the filter material is immersed in a water bath for a period of 2 to 4 hours. The filter material thus formed possesses the characteristics of having an elastic porous property with interstice openings or voids of a substantially equal size with smooth side walls and distributed orderly and evenly therein throughout its entirety. The filter material is basically white in color or it may have other colors such as yellow or black depending on the filler ingredients in the composition.

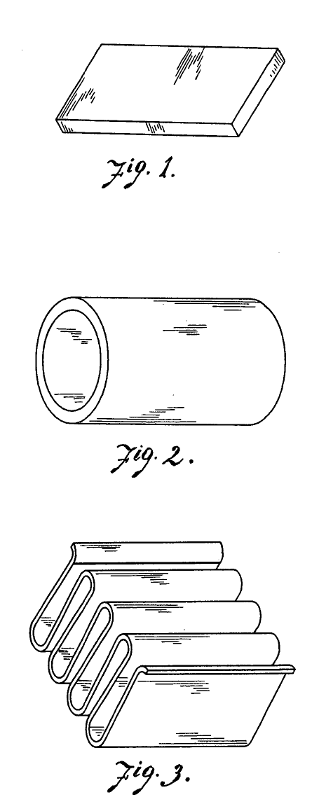

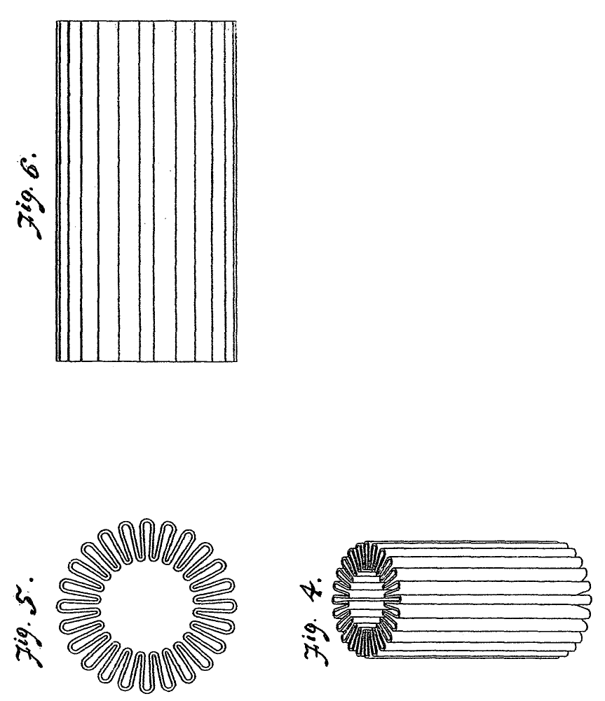

The filter material may be molded into a tubular shape or a sheet form as shown in FIGS. 1 and 2. The flat sheet and the tubular shape may also have a corrugated configuration as shown in FIGS. 3 through 4 in order to increase its effective filtering surface area. The filter element may then be mounted in a housing or enclosure for various filtration applications.

The present filter material is particularly useful for filtering semiconductor material solution such as gallium arsenate in the production of semiconductor crystal in the electronic material industry. The purity of the semiconductor material solution is extremely critical to the quality of the semiconductor material produced.

While only exemplary embodiments of the invention are shown and described, it is apparent that other changes are available within the spirit of the foregoing specification.

1. A filter material having a composition comprising,
a fused mixture of particulate of predetermined sizes of powder ultra high molecular weight polyethylene, low density polyethylene, and high density polyethylene,
said material having evenly distributed interstice openings of substantially equal size and extending from one surface to an opposite surface.

2. A filter material composition according to claim 1 including particulate of filler material powder chosen from the group consisting of: active carbon, polytetrafluoroethylene, salt, and an alkaline.

3. A filter material composition according to claim 2 having
1 portion in proportion by volume of ultra high molecular weight polyethylene powder having a particulate size of 10 to 15 micrometer,
0.15 to 0.4 portion in proportion by volume of low density polyethylene powder having a particulate size of 0.15 to 0.4 micrometer,
0.05 to 0.15 portion in proportion by volume of high density polyethylene powder having a particulate size of 10 to 15 micrometer, and
2.5 to 4.0 portion in proportion by volume of active carbon powder having a particulate size of approximately 20 micrometer.

4. A filter material composition according to claim 2 having
1 portion of in proportion by volume of ultra high molecular weight polyethylene powder having a particulate size of approximately 10 micrometer,
0.1 to 0.2 portion in proportion by volume of polytetrafluoroethylene powder having a particulate size of approximately 15 micrometer,
0.05 to 0.1 portion in proportion by volume of high density polyethylene powder having a particulate size of approximately 15 micrometer,
0.03 to 0.08 portion in proportion by volume of low density polyethylene powder having a particulate size of approximately 15 micrometer,
0.05 to 0.1 portion in proportion by volume of alkaline powder having a particulate size of approximately 10 micrometer, and
0.1 to 0.2 portion in proportion by volume of polyphenylene oxide powder having a particulate size of approximately 15 micrometer.

5. A filter material composition according to claim 2 having
1 portion in proportion by volume of ultra high molecular weight polyethylene powder having a particulate size of 20 to 30 micrometer,
0.10 to 0.20 portion in proportion by volume of high density polyethylene powder having a particulate size of approximately 25 micrometer,
0.03 to 0.08 portion in proportion by volume of low density polyethylene powder having a particulate size of approximately 25 micrometer,
0.05 to 0.15 portion in proportion by volume of polytetrafluoroethylene powder having a particulate size of approximately 25 micrometer,
0.05 to 0.15 portion in proportion by volume of polyamide powder having a particulate size of approximately 25 micrometer,
0.15 to 0.3 portion in proportion by volume of alkaline powder having a particulate size of approximately 20 micrometer, and
0.10 to 0.25 portion in proportion by volume of salt powder having a particulate size of approximately 25 micrometer.

6. A filter material composition according to claim 2 having
1 portion in proportion by volume of ultra high molecular weight polyethylene powder having a particulate size of approximately 40 micrometer,
0.10 to 0.2 portion in proportion by volume of high density polyethylene having a particulate size of approximately 40 micrometer,
0.03 to 0.08 portion in proportion by volume of low density polyethylene having a particulate size of approximately 40 micrometer,
0.05 to 0.15 portion in proportion by volume of polypropylene powder having a particulate size of approximately 40 micrometer,
0.05 to 0.15 portion in proportion by volume of polyamide powder having a particulate size of approximately 40 micrometer,
0.15 to 0.3 portion in proportion by volume of alkaline powder having a particulate size of approximately 20 micrometer, and
0.10 to 0.25 portion in proportion by volume of salt powder having a particulate size of approximately 40 micrometer.

7. A filter material composition according to claim 2 having
1 portion in proportion by volume of ultra high molecular weight polyethylene powder having a particulate size of approximately 25 micrometer,
0.10 to 0.25 portion in proportion by volume of high density polyethylene powder having a particulate size of approximately 30 micrometer,
0.15 to 0.35 portion in proportion by volume of low density polyethylene powder having a particulate size of approximately 30 micrometer,
2.5 to 4.0 portion in proportion by volume of active carbon powder having a particulate size of approximately 20 micrometer, and
0.05 to 0.15 portion in proportion by volume of alkaline powder having a particulate size of approximately 20 micrometer.

8. A process of making a high efficiency filter material comprising the steps of:
mixing a powder mixture of ultra high molecular weight polyethylene, high density polyethylene, low density polyethylene all having predetermined particulate sizes,
placing and compacting said powder mixture in a refractory mold having a predetermined molded shape,
heating said mold in a heating oven to a temperature of 160° C. to 320° C. for 30 to 90 minutes to fuse the mixture to an elastic porous material.

9. A process according to claim 8 including the step of removing said mold with said elastic material therein from said heating oven,
immersing said mold with said elastic material therein into a cold water bath, and
removing said elastic material from said mold.

10. A process according to claim 9 including immersing the elastic material in water for a further period of 2 to 4 hours.
